(19) United States
(12) Patent Application Publication
(10) Pub. No.: US 2024/0348849 A1
(43) Pub. Date: Oct. 17, 2024

(54) DYNAMIC SHORT-FORM VIDEO TRAVERSAL WITH MACHINE LEARNING IN AN ECOMMERCE ENVIRONMENT

(71) Applicant: Loop Now Technologies, Inc., San Mateo, CA (US)

(72) Inventors: Ziming Zhuang, Palo Alto, CA (US); Vishal Arora, Walnut Creek, CA (US)

(73) Assignee: Loop Now Technologies, Inc., San Mateo, CA (US)

(21) Appl. No.: 18/632,427

(22) Filed: Apr. 11, 2024

Related U.S. Application Data
(60) Provisional application No. 63/571,732, filed on Mar. 29, 2024.
(60) Provisional application No. 63/557,623, filed on Feb. 26, 2024.
(60) Provisional application No. 63/557,628, filed on Feb. 26, 2024.
(60) Provisional application No. 63/613,312, filed on Dec. 21, 2023.
(60) Provisional application No. 63/604,261, filed on Nov. 30, 2023.
(60) Provisional application No. 63/546,768, filed on Nov. 1, 2023.
(60) Provisional application No. 63/546,077, filed on Oct. 27, 2023.
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/557,622, filed on Feb. 26, 2024.

(51) Int. Cl. H04N 21/25; G06Q 30/0241; G06Q 30/0601; H04N 21/478

(52) U.S. Cl. CPC H04N 21/25; G06Q 30/0241; G06Q 30/0633; H04N 21/47815

(57) ABSTRACT

Disclosed embodiments provide techniques for dynamic short-form video traversal with machine learning in an ecommerce environment. A graph structure associated with a library of short-form videos is accessed and customized in a back-end environment based on products for sale on a website. One or more of the customized short-form videos from the library are rendered to one or more users, along with an interactive overlay and an ecommerce environment. As the video is viewed, video consumption behavior data is collected and analyzed by a machine learning model. The machine learning model determines one or more next short-form videos from the graph structure for the user to view, based on sales goals, video consumption behavior data, and interaction with the user. The machine learning model can synthesize additional short-form videos and insert them into the graph structure in order to enhance viewer engagement and product sales.

### RELATED APPLICATIONS

This application claims the benefit of U.S. provisional patent applications “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, “Customized Video Playlist With Machine Learning” Ser. No. 63/604,261, filed Nov. 30, 2023, “Artificial Intelligence Virtual Assistant Using Large Language Model Processing” Ser. No. 63/613,312, filed Dec. 21, 2023, “Artificial Intelligence Virtual Assistant With LLM Streaming” Ser. No. 63/557,622, filed Feb. 26, 2024, “Self-Improving Interactions With An Artificial Intelligence Virtual Assistant” Ser. No. 63/557,623, filed Feb. 26, 2024, “Streaming A Segmented Artificial Intelligence Virtual Assistant With Probabilistic Buffering” Ser. No. 63/557,628, filed Feb. 26, 2024, and “Artificial Intelligence Virtual Assistant Using Staged Large Language Models” Ser. No. 63/571,732, filed Mar. 29, 2024.

Each of the foregoing applications is hereby incorporated by reference in its entirety.

### FIELD OF ART

This application relates generally to video analysis and more particularly to dynamic short-form video traversal with machine learning in an ecommerce environment.

### BACKGROUND

“If at first you don't succeed, try, try again” is a proverb that has been a part of the public psyche for generations. The phrase itself was first coined by American educator Thomas H. Palmer in 1840. A few years later, it was used as the basis of a song that appeared in a popular music education textbook. But the idea of tenacity in pursuing a goal is much older than that. The idealism that has pervaded the culture since colonial times continues to tell people that anything is possible in America. From amusement parks to border crossings, in schools, sports, media, and entertainment, we are bombarded with the idea that if we have a dream and pursue it with all our energy and talent, we can, eventually, succeed. There may be many twists and turns in the journey. There may be seemingly insurmountable obstacles. People may tell us that we cannot possibly succeed. But if we stick to it, we will finally come out on top.

This positive, activist attitude is a foundational concept in the area of sales and marketing. Sales strategies abound, using various forms of media, hard sell methods, soft sell methods, sales based on relationships, sales based on targeted interests, and so on. Salespeople are inundated with new techniques, updated technologies, seminars, books, videos, and every other imaginable method of finding and persuading customers to purchase their products and services. One might say, to a large degree, the sales industry is its own best customer. Of course, a well-defined sales strategy can truly be crucial to both personal and organizational success. A clear strategy gives direction and focus for the sales staff. It can provide clear goals and methods to prioritize, which can in turn lead to greater productivity. Messaging can be made consistent with the goals of the organization, making sure that communications with customers, partners, and prospects are well thought out and aligned. Resources can be allocated efficiently and effectively, allowing the sales staff to use the right tools, in the right spots, at the appropriate time.

Technology can be applied to increase the effectiveness of sales efforts. An analysis of an organization's customer base can reveal segments based on demographics, behaviors, or shared needs. Different sales approaches can be devised to address each segment. If a particular approach is ineffective, the “try, try, again” principle can be put into practice across the segment with greater efficiency. What works best can be a practical driver for deciding what strategy to use. As the sales staff interacts with customers and prospects, feedback can be forwarded to the product development teams. The better organized the sales organization is, the better it can tailor and shape messages and delivery systems to address the needs of its customers.

### SUMMARY

The history of ecommerce began in the late 1970s, when an English inventor developed teleshopping. This service allowed television viewers to call a phone number which could take orders for items for sale presented on a television show. Soon after, a group of French businessmen launched a subscription service which allowed users to order goods and services using a video text terminal connected to telephone lines. In 1991, the World Wide Web internet service launched, and was quickly followed by an online bookstore in 1992. Amazon™ started as a similar online service in 1994. This company made a key contribution to ecommerce by allowing users to review products online and share the reviews with other users. Online auctions, clearinghouses for handmade arts and crafts, and specialty online stores of all kinds quickly joined into the rapidly expanding ecommerce environment. In 2001, mobile websites began to appear, allowing shoppers to not only purchase products, but also to research products, find coupons, compare prices, and review products on social media sites. Livestreaming added to the ability to review, comment, ask questions, and interact with other shoppers, hosts, product experts, and celebrities in real time as purchases were being made. Like eating potato chips, many viewers of short-form videos such as livestreams cannot watch “just one”. Roughly two-thirds of internet users prefer video as their primary source of information. The average viewer spends nearly two hours per day watching videos, many of which are less than a minute long. Most of these viewers skip advertising videos and sections of other videos that are clearly commercials. Thus, identifying short-form videos that engage viewers and lead to purchases of products is vital to ecommerce marketers. Even more important, finding patterns in groups of short-form videos that command viewer attention and influence them to buy goods and services is key to a winning ecommerce marketing strategy.

Disclosed embodiments provide techniques for dynamic short-form video traversal with machine learning in an ecommerce environment. A graph structure associated with a library of short-form videos is accessed and customized in a back-end environment based on products for sale on a website. One or more of the customized short-form videos from the library is rendered to one or more users, along with an interactive overlay and an ecommerce environment. As the video is viewed, video consumption behavior data is collected and analyzed by a machine learning model. The machine learning model determines one or more next short-form videos from the graph structure for the user to view, based on sales goals, video consumption behavior data, and interaction with the user. The machine learning model can synthesize additional short-form videos and insert them into the graph structure in order to enhance viewer engagement and product sales.

A computer-implemented method for video analysis is disclosed comprising: accessing a graph structure associated with a plurality of short-form videos, wherein the plurality of short-form videos is selected from a library of short-form videos; customizing the graph structure in a back-end environment, wherein the customizing is based on one or more products for sale on a website; rendering, to one or more users, at least one of the plurality of short-form videos in accordance with the graph structure; collecting, from the user, video consumption behavior, as the plurality of short-form videos is rendered; and determining, based on the video consumption behavior, one or more next short-form videos to be shown, wherein the determining is based on a sales goal and wherein the determining is accomplished by a machine learning model. Some embodiments comprise synthesizing a next short-form video to be shown to the user, wherein the synthesizing is accomplished by the machine learning model. Some embodiments comprise adding an interactive overlay to the next short-form video to be shown which was synthesized, wherein the adding is accomplished by machine learning. In embodiments, the next short-form video is added to the graph structure. Some embodiments comprise adding a coupon within the interactive overlay. In embodiments, the coupon is based on the sales goal.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for dynamic short-form video traversal with machine learning in an ecommerce environment.

FIG. 2 is an infographic for dynamic short-form video traversal with machine learning in an ecommerce environment.

FIG. 3 is an infographic for a short-form video with synthetic scene insertion.

FIG. 4 is an example synthesized short-form video.

FIG. 5 is an infographic for updating a tree structure.

FIG. 6 illustrates an ecommerce purchase.

FIG. 7 is a system diagram for dynamic short-form video traversal with machine learning in an ecommerce environment.

### DETAILED DESCRIPTION

Short-form videos with an engaging host highlighting and demonstrating products can be an effective way of engaging customers and promoting sales. Identifying patterns of short-form videos that work together to promote viewer engagement and decisions to purchase can improve ecommerce even more. Libraries of short-form videos can be accessed and tailored to promote products and services offered by an ecommerce website. The short-form videos that match up with products and services from the website can be linked together in a tree-like graphic structure so that as a website user watches one short-form video and then another, the sequence of videos can be tracked and analyzed by a machine learning model. The machine learning model can be taught to identify patterns of short-form videos that lead to sales of products and longer engagement of viewers. An ecommerce environment allowing users to purchase products can be integrated into the short-form videos as they are seen by viewers. An interactive overlay can also be added so that viewers can respond to the short-form videos as the videos play. Viewers can ask questions, make comments, give thumbs up or down, and respond to prompts generated by the machine learning model. The machine learning model can prompt viewers regarding related short-form videos so that the viewer remains engaged. Over time, the model can learn to prompt viewers to follow sequences of short-form videos that tend to lead to greater product sales. The machine learning model can also generate synthetic short-form videos when they are needed to respond to questions or comments not addressed by videos in the library, to improve viewer engagement, to change video hosts, or to introduce related products and services offered by the ecommerce website. As the machine learning model grows and the short-form video library expands, the ability to hold viewer interest and expand market share improves.

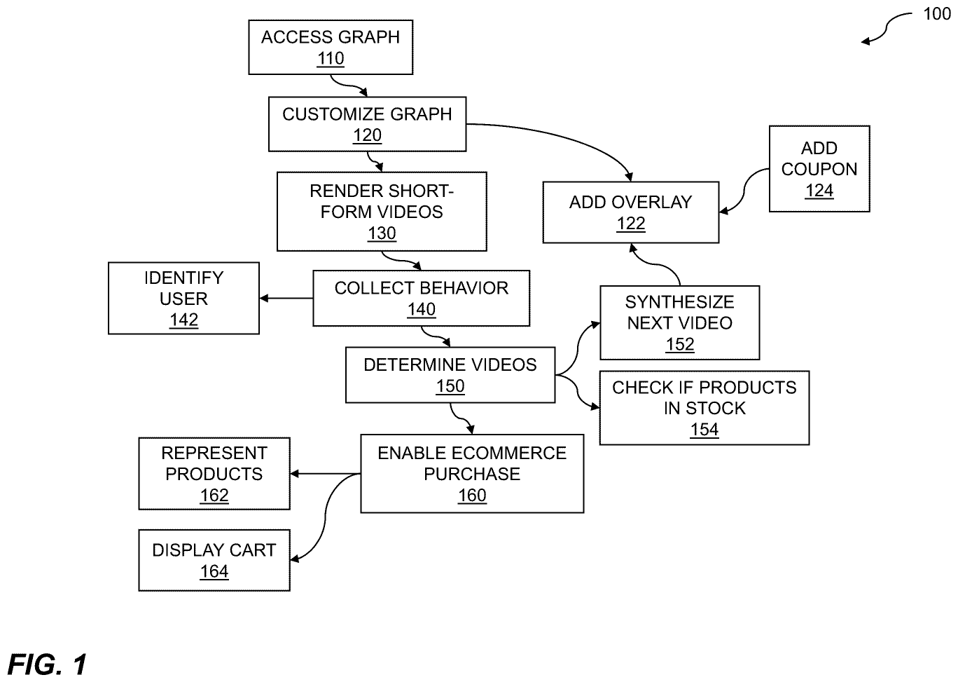

FIG. 1 is a flow diagram for dynamic short-form video traversal with machine learning in an ecommerce environment. The flow 100 includes accessing a graph structure 110 associated with a plurality of short-form videos, wherein the plurality of short-form videos is selected from a library of short-form videos. In embodiments, the graph structure associated with the plurality of short-form videos includes a tree structure. The graph structure is displayed in a back-end environment. The library of short-form videos can be compiled from multiple sources, including vendor websites, social media platforms, livestreams, marketing videos, product expert demonstrations, and so on. The graph structure is a decision support model that uses a tree-like model of decisions and possible consequences. In some embodiments, the graph tree structure can be displayed visually as a series of nodes or decision points connected by lines leading to additional decision point nodes. In some embodiments, the decision graph structure is displayed in a left-to-right orientation. Other embodiments can display the graph structure in a top-to-bottom arrangement. Each user choice or decision point can represent a short-form video that can lead a user to select another related short-form video. As a user selects the first short-form video to view at the left side or top of the graph, a series of choices representing the possible next steps can be represented as a series of lines leading to subsequent user choices. Additional information can be added to the graph structure to indicate decisions to purchase products, to return to a previous video, to rewatch a video, to stop watching videos, and so on. As the user continues to make choices, the active decision point progresses from left to right or top to bottom, traversing the graphical display. In embodiments, each choice made by the user is stored and fed into a machine learning model, along with information related to the short-form videos being viewed, products being purchased, and so on.

The flow 100 includes customizing the graph structure 120 in a back-end environment, wherein the customizing is based on one or more products for sale on a website. The customizing can include adding an interactive overlay 122 to one or more of the plurality of short-form videos that were selected from the library. The flow 100 can include adding a coupon 124 within the interactive overlay. Various coupons can be added to encourage product sales and increase viewer engagement. In embodiments, the coupon is based on the sales goal.

A list of products and services for sale on a website can be stored and associated with short-form videos stored in the library of short-form videos. The associations can be based on metadata on each product or service, including product name, category, size, price, color, and so on. In some embodiments, the associations can be made by a machine learning model. The machine learning model can analyze the contents of the short-form videos in the library and match product names, categories, and so on to products and services supplied by an ecommerce website. As matches are made between products offered by the ecommerce website and short-form videos in the library, the graph structure can be customized to display the matched short-form videos and a first-pass arrangement of the short-form videos based on associations between the matched short-form videos. The first-pass arrangement can be assembled by one or more human operators or by the machine learning model. For example, a short-form video highlighting a soup pot can be linked to another short-form video demonstrating preparation of a soup recipe. The same soup pot video can also be linked to a short-form video highlighting a set of soup bowls. Another link can be made to a short-form video highlighting a complete set of cooking vessels, and so on. At each decision tree point, additional information can be collected which can relate to viewer decisions to purchase products, ask questions, make comments, stop watching, and so on.

The flow 100 includes rendering, to a user, at least one of the plurality of short-form videos 130 in accordance with the graph structure. In embodiments, the rendering includes a plurality of users. One or more users can be presented with one or more short-form videos related to a product or service for sale on an ecommerce website. The rendering of the short-form videos can be based on a question or comment made by a user, on a click or other form of selection of a product displayed on the website, or in response to a direct user selection of the video from the website. The rendering includes adding an interactive overlay 122, which allows the user to respond to the short-form video as it plays. Questions or comments can be recorded; choices of additional short-form videos can be presented and selected; options to purchase products or services portrayed in the video can be chosen; options to replay the short-form video, go back to a previous video, or stop watching videos can be selected; and so on. As described in later steps, an ecommerce environment can be rendered with the interactive overlay so that the user can select items to be purchased immediately or at a later time.

The flow 100 includes collecting, from the user, video consumption behavior 140, as the plurality of short-form videos are rendered. The collecting can include identifying a user 142 or a plurality of users. Metadata related to the one or more users can be collected, including the user's name, location, purchases, payment preferences, likes, number of visits, hashtags, repost velocity, view attributes, view history, ranking, influencers followed, and so on. Data from the website can also be collected, including purchase history, shipping information, etc. The viewer consumption information can include likes, dislikes, view count, click-through rate (CTR), view duration, percentage viewed, text comments and questions, purchase choices, and responses to questions generated by the machine learning model.

The flow 100 includes determining, based on the video consumption behavior, one or more next short-form videos 150 to be shown, wherein the determining is based on a sales goal and wherein the determining is accomplished by a machine learning model. A machine learning model is comprised of a group of computer programs that is used to recognize patterns in data and make predictions. The computer programs are created from machine learning algorithms that can be trained with data based on the types of predictions desired from the model. In embodiments, the machine learning model can be trained with website and user metadata, short-form videos, video metadata, purchase history, product information, and so on, in order to predict patterns of short-form video viewing and engagement choices that lead to purchases of products and services. In embodiments, the determining is based on the identifying.

As viewers interact with and respond to multiple groups of short-form videos, over time the machine learning model becomes better at predicting traversal patterns of short-form video views that result in greater engagement and purchase choices. The machine learning model can also generate questions and choices that lead viewers to select the next short-form video best suited to selecting additional short-form videos and to purchasing products. In embodiments, the next short-form video to be shown can be customized based on one or more products for sale on a website. The customizing includes adding an interactive overlay to one or more of the plurality of short-form videos that were selected from the library. The determining further comprises checking if the one or more products for sale is in stock 154. As the machine learning model takes in viewer responses to the short-form video, questions can be put to the user that can lead to additional short-form videos. For example, a user watching a short-form video on golf can be asked, “What would you like to do today?” including choices such as “Improve Your Swing”, “Take Online Lessons”, and “Shop for Gear”. Each option can be linked to a short-form video from the customized graph structure. The short-form videos can be customized to highlight products that have been confirmed to be in stock and are available for purchase from the ecommerce website.

In some embodiments, the determining further comprises synthesizing 152 a next short-form video to be shown to the user, wherein the synthesizing is accomplished by machine learning. In embodiments, the synthesized next short-form video can be customized based on one or more products for sale on a website. The customizing includes adding an interactive overlay to the synthesized short-form video. The synthesized next short-form video can be added to the graph structure. As the machine learning model takes in viewer consumption behavior data and short-form video information, it can find patterns that lead to viewers leaving the ecommerce site or abandoning the short-form video platform. It may record questions or comments made by users that relate to products being offered by the ecommerce website, but have no related short-form video available in the video library. The machine learning model may find that a particular short-form video related to a comment or question, or selected based on a machine learning model interaction, results in no next video being chosen. Any of these patterns can lead to the machine learning model synthesizing a short-form video designed to better engage the viewer and lead to purchases being made.

In embodiments, the machine learning model can access photorealistic representations of individuals from one or more media sources. The media sources can include photographs, videos, livestream events, and livestream replays, including the voice of the individual. The machine learning model can isolate the representations of an individual in videos and photographs and use them to generate a three-dimensional (3D) model of the individual. In some embodiments, the photorealistic representation can include a 360° representation of an individual. The first individual can comprise a human host that can be recorded with one or more cameras, including videos and still images, and microphones for voice recording. The recordings can include one or more angles of the human host and can be combined to comprise a dynamic 360° photorealistic representation of the human host. The voice of the human host can be recorded and included in the representation of the human host.

The 3D model of the individual can be generated and refined using a game engine. A game engine is a set of software applications that work together to create a framework for users to build and create video games. Game engines can be used to render graphics, generate and manipulate sound, create and modify physics within the game environment, detect collisions, manage computer memory, and so on. In embodiments, the isolated and categorized photorealistic images of an individual can be used as input to a machine learning game engine that can build a detailed 3D model of the individual, including the voice of the individual extracted from the video and livestream recordings. The game engine can include a Character Movement Component that provides common modes of movement for 3D humanoid characters, including walking, falling, swimming, crawling, and so on. These default movement modes are built to replicate by default and can be modified to create customized movements, such as skiing, scuba diving, or demonstrating a product. Facial features can be edited to appear more lifelike, including storing unique and idiosyncratic elements of a human face. Articles of clothing can be similarly edited to perform as they do in real life. Lighting presets can be used to place individual characters in photorealistic environments so that light sources, qualities, and shadows appear lifelike. Voice recordings can be used to generate dialogue with the same vocal qualities as the first individual. Volume, pitch, rhythm, frequency, and so on can be manipulated within the game engine to create realistic dialogue for the 3D model of the individual. The game engine can be used to generate a series of animated movements, including basic actions such as sitting, standing, holding a product, presenting a video or photograph, describing an event, and so on. Specialized movements can be programmed and added to the animation as needed. Dialogue can be added so that the face of the presenter moves appropriately as the words are spoken. The 3D model of the host individual can be used as the performer of the animation after the sequence of movements and dialogues have been decided. The result is a synthesized performance by the selected host model, combining the animation generated by the game engine and the 3D model of the individual, including the voice of the individual. The synthesized performance can be used to create the next short-form video which can better respond to viewer questions or comments related to a previous short-form video, and can raise viewer engagement and sales choices. Once the synthesized short-form video is generated, it can be added to the customized graph structure and rendered to the viewer, including an interactive overlay and ecommerce environment. As the machine learning model takes in viewer consumption behavior related to the synthesized short-form video, it can adjust the performance of the host, the highlighting of the product, and so on in order to generate higher viewer engagement and sales scores.

The flow 100 further comprises enabling an ecommerce purchase 160, within an ecommerce environment, of one or more products for sale, wherein the enabling the ecommerce purchase includes a virtual purchase cart. In embodiments, the rendering further comprises displaying 164, within the at least one of the plurality of short-form videos that was rendered, the virtual purchase cart. In some embodiments, the virtual purchase cart covers a portion of the at least one of the plurality of short-form videos that was rendered. The at least one of the plurality of short-form videos that was rendered includes highlighting the one or more products for sale to the user. The enabling further comprises representing 162 the one or more products for sale in an on-screen product card. The enabling the ecommerce purchase includes a virtual purchase cart, wherein the rendering further comprises displaying, within the first short-form video that was rendered, the virtual purchase cart. The virtual purchase cart can cover a portion of the first short-form video. A device used to view the rendered short-form video can be an Over-the-Top (OTT) device such as a mobile phone, laptop computer, tablet, pad, desktop computer, etc. The viewing of the short-form video can be accomplished using a browser or another application running on the device. A product card can be generated and rendered on the device for viewing the short-form video. In embodiments, the product card represents at least one product available for purchase on the website or social media platform hosting the short-form video or highlighted during the short-form video. Embodiments can include inserting a representation of a product for sale into the on-screen product card. A product card is a graphical element such as an icon, thumbnail picture, thumbnail video, symbol, or another suitable element that is displayed in front of the video. The product card is selectable via a user interface action such as a press, swipe, gesture, mouse click, verbal utterance, or some other suitable user action. When the product card is invoked, an in-frame shopping environment can be rendered over a portion of the short-form while the chat continues to play. This rendering enables an ecommerce purchase by a user while preserving a short-form video session. In other words, the user is not redirected to another site or portal that causes the short-form video to stop. Thus, viewers can initiate and complete a purchase completely inside of the short-form video user interface, without being directed away from the currently playing video. Allowing the short-form video to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

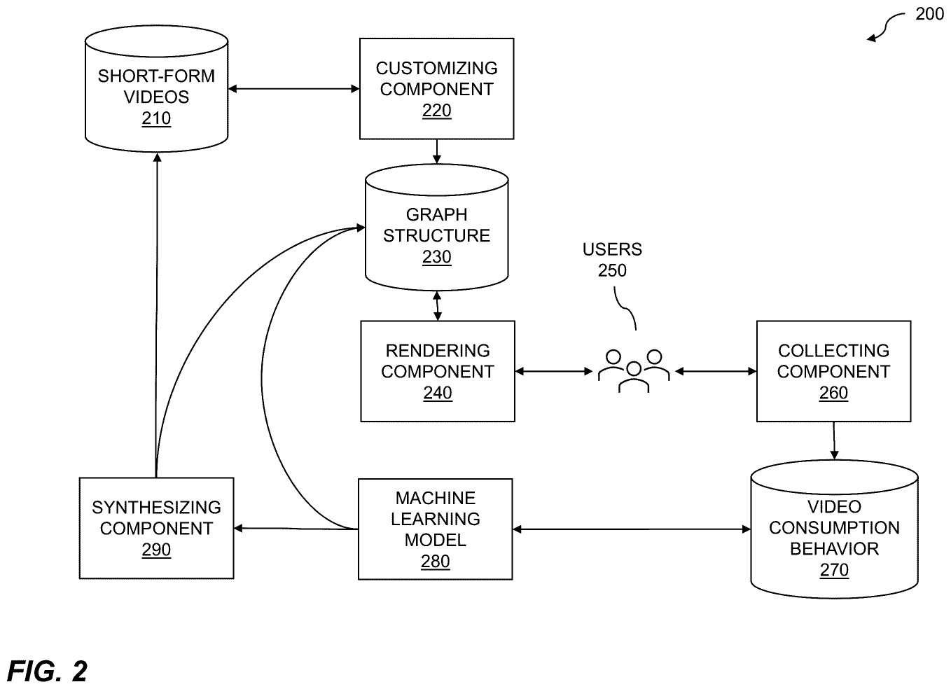

FIG. 2 is an infographic for dynamic short-form video traversal with machine learning in an ecommerce environment. The infographic 200 includes accessing a graph structure 230 associated with a plurality of short-form videos 210, wherein the plurality of short-form videos is selected from a library of short-form videos. In embodiments, the graph structure 230 associated with the plurality of short-form videos includes a tree structure. The graph structure is displayed in a back-end environment. The library of short-form videos 210 can be compiled from multiple sources, including vendor websites, social media platforms, livestreams, marketing videos, product expert demonstrations, and so on. The graph structure is a decision support model that uses a tree-like model of decisions and possible consequences. In some embodiments, the graph tree structure can be displayed visually as a series of nodes or decision points connected by lines leading to additional decision point nodes. In some embodiments, the decision graph structure is displayed in a left-to-right orientation. Other embodiments can display the graph structure in a top-to-bottom arrangement. Each user choice or decision point can represent a short-form video that can lead a user to select another related short-form video. As a user 250 selects the first short-form video to view at the left side or top of the graph, a series of choices representing the possible next steps can be represented as a series of lines leading to subsequent user choices. Additional information can be added to the graph structure to indicate decisions to purchase products, to return to a previous video, to rewatch a video, to stop watching videos, and so on. As the user continues to make choices, the active decision point progresses from left to right or top to bottom, traversing the graphical display. In embodiments, each choice made by the user is stored and fed into a machine learning model, along with information related to the short-form videos being viewed, products being purchased, and so on.

The infographic 200 includes a customizing component 220. The customizing component 220 is used to customize the graph structure 230 in a back-end environment, wherein the customizing is based on one or more products for sale on a website. In embodiments, the customizing includes adding an interactive overlay to one or more of the plurality of short-form videos that were selected from the library. A list of products and services for sale on a website can be stored and associated with short-form videos stored in the library of short-form videos. The associations can be based on metadata on each product or service, including product name, category, sizes, price, color, and so on. In some embodiments, the associations can be made by a machine learning model. The machine learning model can analyze the contents of the short-form videos in the library and match product names, categories, and so on to products and services supplied by an ecommerce website. As matches are made between products offered by the ecommerce website and short-form videos in the library, the graph structure can be customized to display the matched short-form videos and a first-pass arrangement of the short-form videos based on associations between the matched short-form videos. The first-pass arrangement can be assembled by one or more human operators or by the machine learning model. For example, a short-form video highlighting a soup pot can be linked to another short-form video demonstrating the preparation of a soup recipe. The same soup pot video can also be linked to a short-form video highlighting a set of soup bowls. Another link can be made to a short-form video highlighting a complete set of cooking vessels, and so on. At each decision tree point, additional information related to viewer decisions to purchase products, ask questions, make comments, stop watching, and so on can be collected.

The infographic 200 includes a rendering component 240. The rendering component 240 is used to render, to a user 250, at least one of the plurality of short-form videos 210 in accordance with the graph structure. In embodiments, the rendering includes a plurality of users. The user or users can be presented with one or more short-form videos that have been customized to highlight a product or service for sale on an ecommerce website. The rendering of the short-form videos can be based on a question or comment made by a user, on a click or other form of selection of a product displayed on the website, or in response to a direct user selection of the video from the website. The rendering includes an interactive overlay which allows the user to respond to the short-form video as it plays. Questions or comments can be recorded; choices of additional short-form videos can be presented and selected; options to purchase products or services portrayed in the video can be chosen; options to replay the short-form video, go back to a previous video, or stop watching videos can be selected; and so on. As described in later steps, an ecommerce environment can be rendered with the interactive overlay so that the user can select items to be purchased immediately or at a later time.

The rendering component 240 further comprises enabling an ecommerce purchase, within an ecommerce environment, of one or more products for sale, wherein the enabling the ecommerce purchase includes a virtual purchase cart. In embodiments, the rendering further comprises displaying, within the at least one of the plurality of short-form videos that was rendered, the virtual purchase cart. In some embodiments, the virtual purchase cart covers a portion of the at least one of the plurality of short-form videos that was rendered. The at least one of the plurality of short-form videos that was rendered includes highlighting the one or more products for sale to the user. The enabling further comprises representing the one or more products for sale in an on-screen product card. The enabling the ecommerce purchase includes a virtual purchase cart, wherein the rendering further comprises displaying, within the first short-form video that was rendered, the virtual purchase cart. The virtual purchase cart can cover a portion of the first short-form video. A device used to view the rendered short-form video can be an Over-the-Top (OTT) device such as a mobile phone, laptop computer, tablet, pad, or desktop computer, etc. The viewing of the short-form video can be accomplished using a browser or another application running on the device. A product card can be generated and rendered on the device for viewing the short-form video. In embodiments, the product card represents at least one product available for purchase on the website or social media platform hosting the short-form video or highlighted during the short-form video. Embodiments can include inserting a representation of a product for sale into the on-screen product card. A product card is a graphical element such as an icon, thumbnail picture, thumbnail video, symbol, or another suitable element that is displayed in front of the video. The product card is selectable via a user interface action such as a press, swipe, gesture, mouse click, verbal utterance, or some other suitable user action. When the product card is invoked, an in-frame shopping environment can be rendered over a portion of the short-form video while the chat continues to play. This rendering enables an ecommerce purchase by a user while preserving a short-form video session. In other words, the user is not redirected to another site or portal that causes the short-form video to stop. Thus, viewers can initiate and complete a purchase completely inside of the short-form video user interface, without being directed away from the currently playing video. Allowing the short-form video to play during the purchase can enable improved audience engagement, which can lead to additional sales and revenue, one of the key benefits of disclosed embodiments. In some embodiments, the additional on-screen display that is rendered upon selection or invocation of a product card conforms to an interactive advertising bureau (IAB) format. A variety of sizes are included in IAB formats, such as for a smartphone banner, mobile phone interstitial, and the like.

The infographic 200 includes a collecting component 260. The collecting component 260 is used to collect, from the users 250, video consumption behavior 270, as the plurality of short-form videos 210 is rendered. In embodiments, the collecting component 260 further comprises identifying the user 250 or plurality of users. Metadata related to the one or more users including the user's name, location, purchases, payment preferences, likes, number of visits, hashtags, repost velocity, view attributes, view history, ranking, influencers followed, and so on can be collected. Data from the website including purchase history, shipping information, etc. can also be collected. The viewer consumption information can include likes, dislikes, view count, click through rate (CTR), view duration, percentage viewed, text comments and questions, purchase choices, product card selections, and responses to questions generated by the machine learning model.

The infographic 200 includes determining, based on the video consumption behavior 270, one or more next short-form videos 210 to be shown, wherein the determining is based on a sales goal and wherein the determining is accomplished by a machine learning model 280. A machine learning model is comprised of a group of computer programs that are used to recognize patterns in data and make predictions. The programs are created from machine learning algorithms that can be trained with data based on the types of predictions desired from the model. In embodiments, the machine learning model can be trained with website and user metadata, short-form videos, video metadata, purchase history, product information, and so on, in order to predict patterns of short-form video viewing and engagement choices that lead to purchases of products and services. As viewers interact with and respond to multiple groups of short-form videos, over time the machine learning model becomes better at predicting traversal patterns of short-form video views that result in greater engagement and purchase choices. The machine learning model can also generate questions and choices that lead viewers to select a next short-form video best suited to selecting additional short-form videos and to purchasing products. In embodiments, the next short-form video to be shown can be customized based on one or more products for sale on a website. The customizing includes adding an interactive overlay to one or more of the plurality of short-form videos that were selected from the library. The determining further comprises checking to determine if the one or more products for sale is in stock. As the machine learning model takes in viewer responses to the short-form video, questions can be put to the user that can lead to the selection of additional short-form videos to view. For example, a user watching a short-form video on golf can be asked, “What would you like to do today?” including choices such as “Improve Your Swing”, “Take Online Lessons”, and “Shop for Gear”. Each option can be linked to a short-form video from the customized graph structure. The short-form videos can be customized to highlight products that have been confirmed to be in stock and available for purchase from the ecommerce website.

The infographic 200 includes a synthesizing component 290. The synthesizing component 290 is used to synthesize a next short-form video to be shown to the user 250, wherein the synthesizing is accomplished by a machine learning model 280. In embodiments, the synthesized next short-form video can be customized based on one or more products for sale on a website. The customizing can include adding an interactive overlay to the synthesized short-form video. The synthesized next short-form video can be added to the graph structure. As the machine learning model takes in viewer consumption behavior data and short-form video information, it can find patterns that lead to viewers leaving the ecommerce site or abandoning the short-form video platform. It may record questions or comments made by users that relate to products being offered by the ecommerce website, but have no related short-form video available in the video library. The machine learning model may find that a short-form video related to a comment, question, or selection based on a machine learning model interaction results in no next video being chosen. Any of these patterns can lead to the machine learning model synthesizing a short-form video designed to better engage the viewer and lead to purchases being made.

In embodiments, the machine learning model can access photorealistic representations of individuals from one or more media sources. The media sources can include photographs, videos, livestream events, and livestream replays, including the voice of the individual. The machine learning model can isolate the representations of an individual in videos and photographs and use them to generate a 3D model of the individual. In some embodiments, the photorealistic representation can include a 360° representation of an individual. The first individual can comprise a human host to be used in the synthesized short-form video that can be recorded with one or more cameras, including videos and still images, and microphones for voice recording. The recordings can include one or more angles of the human host and can be combined to comprise a dynamic 360° photorealistic representation of the human host. The voice of the human host can be recorded and included in the representation of the human host.

The 3D model of the host individual can be generated and refined using a game engine. A game engine is a set of software applications that work together to create a framework for users to build and create video games. They can be used to render graphics, generate and manipulate sound, create and modify physics within the game environment, detect collisions, manage computer memory, and so on. In embodiments, the isolated and categorized photorealistic images of an individual can be used as input to a machine learning game engine that can build a detailed 3D model of the individual, including the voice of the individual extracted from the video and livestream recordings. The game engine can include a character movement component that provides common modes of movement for 3D humanoid characters including walking, falling, swimming, crawling, and so on. These default movement modes are built to replicate by default and can be modified to create customized movements, such as skiing, scuba diving, or demonstrating a product. Facial features can be edited to appear more lifelike, including storing unique and idiosyncratic elements of a human face. Articles of clothing can be similarly edited to perform as they do in real life. Lighting presets can be used to place individual characters in photorealistic environments so that light sources, qualities, and shadows appear lifelike. Voice recordings can be used to generate dialogue with the same vocal qualities as the first individual. Volume, pitch, rhythm, frequency, and so on can be manipulated within the game engine to create realistic dialogue for the 3D model of the individual. The game engine can be used to generate a series of animated movements, including basic actions such as sitting, standing, holding a product, presenting a video or photograph, describing an event, and so on. Specialized movements can be programmed and added to the animation as needed. Dialogue can be added so that the face of the presenter moves appropriately as the words are spoken. The 3D model of the host individual can be used as the performer of the animation after the sequence of movements and dialogues have been decided. The result is a synthesized performance by the selected host model, combining the animation generated by the game engine and the 3D model of the individual, including the voice of the individual. The synthesized performance can be used to create the next short-form video that can better respond to viewer questions or comments related to a previous short-form video and raise viewer engagement and sales choices. Once the synthesized short-form video is generated, it can be added to the customized graph structure and rendered to the viewer, and can include an interactive overlay and ecommerce environment. As the machine learning model takes in viewer consumption behavior related to the synthesized short-form video, it can adjust the performance of the host, the highlighting of the product, and so on in order to generate higher viewer engagement and sales scores.

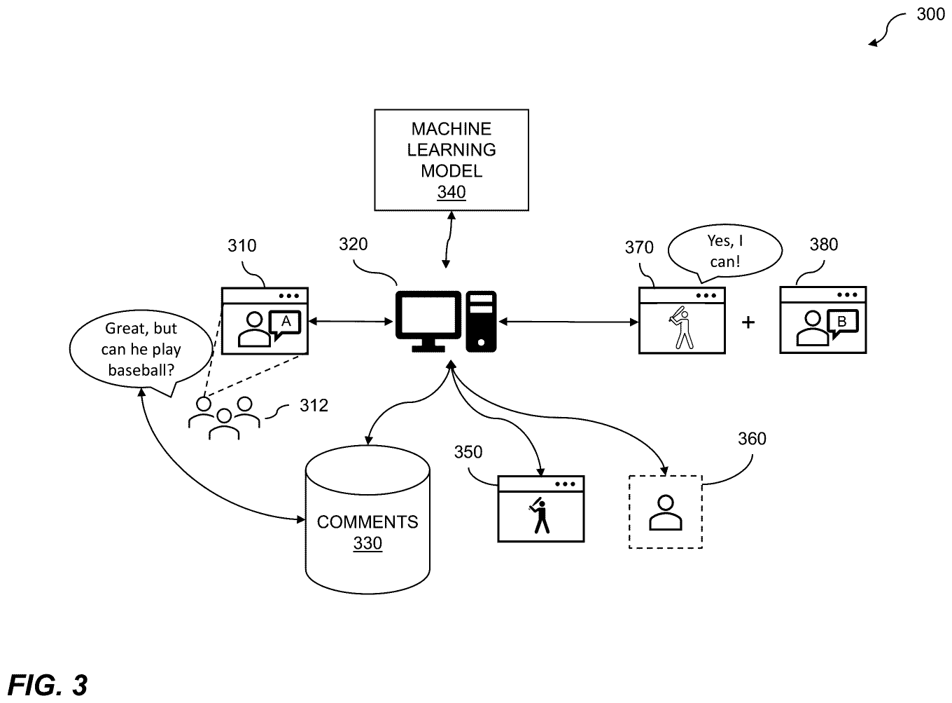

FIG. 3 is an infographic 300 for a short-form video with synthetic scene insertion. A short-form video can be accessed and presented to a group of viewers. The rendering of the short-form video can be accessed by viewers in real time, allowing interaction between viewers and operators of the livestream. An interactive overlay can be rendered with the short-form video, allowing questions, comments, likes, dislikes, etc. to be added by viewers as they view the video. Short-form video segments related to products and subjects discussed during the short-form video can be accessed by the operator of the website rendering the video. An ecommerce environment can also be rendered with the short-form video, allowing purchases to be completed as the video plays. Additional video segments can be selected based on video consumption behaviors by viewers during the rendering of the short-form video in addition to segments preselected based on subjects and products discussed in one or more short-form videos. The host individual performing in the video segments can be a synthetic presenter generated as part of a synthetic short-form video created by an AI machine learning model. Images of the livestream host can be collected and combined using artificial intelligence (AI) machine learning to create a 3D model of the host, including facial features, expressions, gestures, clothing, accessories, etc. The 3D model of the host can be combined with the video segments to create synthesized video segments in which the livestream host is seen as the presenter. AI machine learning can be used to swap the voice of the video segment individual presenter with the voice of the livestream host. Thus, the host of the prerecorded livestream becomes the presenter of the synthesized video segments for the viewers.

The infographic 300 includes viewers 312 watching a short-form video 310. The short-form video can be part of a library of short-form videos associated with a graph structure. In embodiments, the graph structure associated with the library of short-form videos includes a tree structure. The graph structure is displayed in a back-end environment. The library of short-form videos can be compiled from multiple sources, including vendor websites, social media platforms, livestreams, marketing videos, product expert demonstrations, and so on. The graph structure is a decision support model that uses a tree-like model of decisions and possible consequences. Each user choice or decision point can represent a short-form video that can lead a user to select another related short-form video. As a user selects the first short-form video to view at the left side or top of the graph, a series of choices representing the possible next steps can be represented as a series of lines leading to subsequent user choices. Additional information can be added to the graph structure to indicate decisions to purchase products, to return to a previous video, to rewatch a video, to stop watching videos, and so on. As the user continues to make choices, the active decision point progresses from left to right or top to bottom, traversing the graphical display. In embodiments, each choice made by the user is stored and fed into a machine learning model, along with information related to the short-form videos being viewed, products being purchased, and so on.

The infographic 300 includes an operator 320 that can monitor the short-form video as viewers 312 watch and interact with the short-form video 310. In embodiments, the operator 320 can listen to verbal comments made by viewers 312, see comments and questions made by viewers in a chat as part of an interactive overlay associated with the short-form video, and so on. The operator 320 can use an artificial intelligence (AI) machine learning model 340 with access to a library of related short-form video segments 350. The operator can use the video segments to respond to the comments 330 of viewers 312 as the short-form video 310 is rendered. For example, the comment, “Great, but can he play baseball?” can be made by a viewer 312 as the short-form video 310 is rendered to the viewers 312. The comment can be recorded and accessed by the short-form video operator 320. The short-form video operator can access a library of related video segments and select a video segment that includes an individual playing baseball.

The infographic 300 includes one or more images of the short-form video host 360. In embodiments, one or more images of the host 360 can be retrieved from the prerecorded video and from other sources, including short-form videos and still photographs. Using a machine learning artificial intelligence (AI) neural network, the images of the host 360 can be used to create a 3D model of the host, including facial expressions, gestures, articles of clothing, accessories, and so on. The various components of the 3D model can be isolated and swapped out as desired, so that a product for sale or alternate article of clothing can be included in a synthesized video using the 3D model. The 3D model of the host can be built using a generative model. The generative model can include a generative adversarial network (GAN). Using the GAN, the images of the short-form video host 360 can be combined with the video segment 350 to create a synthesized video segment 370 in which the short-form video host renders the performance of the individual in the video segment.

The infographic 300 includes the operator 320 using an AI machine learning model 340 to dynamically insert a synthesized video segment 370 into the short-form video 310. In embodiments, the inserting of the synthesized video segment 370 forms a response to comments 330 made by viewers 312 as the short-form video 310 is rendered. For example, the synthesized video segment that combines the images of the host 360 with the individual playing baseball 350 can be dynamically inserted by the short-form video operator 320. The synthesized video segment forms a response to the viewer question, “Great, but can he play baseball?” An Al-generated voice response, “Yes, I can!”, using the voice of the short-form video host, can be added to the synthesized video segment by the short-form video operator 320 to further enhance the experience of the viewers 312 as the video segment is rendered.

The infographic 300 includes rendering the remainder of the short-form video 380 after the synthesized video segment 370 insertion. A stitching process can be used to create a seamless transition from the short-form video 310 to the synthesized video segment 370. A similar stitching process can be used to create a seamless transition from the end of the synthesized video segment 370 to the remainder of the short-form video 380. The stitching occurs at one or more boundary frames at the insertion point between the synthesized video segment 370 and the remainder of the short-form video 380. The stitching process may use copies of frames from other points in the short-form video 310 or the synthesized video segment 370. It may repeat frames within either video or delete frames as needed in order to produce the least noticeable transition from the short-form video to the synthesized video. Thus, the viewers 312 are dynamically engaged as the short-form video operator 320 uses synthesized video segments 370 to respond directly to viewer comments 330 as they occur in real time during replay of the short-form video 310.

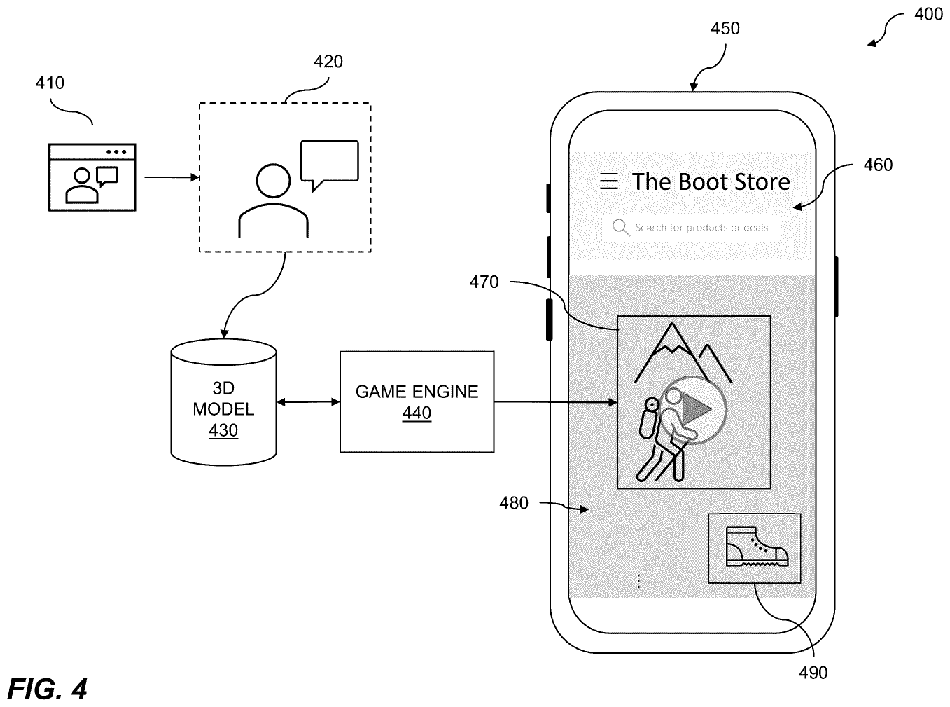

FIG. 4 is an example synthesized short-form video. The example 400 includes accessing a photorealistic representation 410 of an individual from one or more media sources. In embodiments, viewer information can be collected that can be used to select the individual for the synthesized host performance. The viewer information can include purchase history, view history, and metadata from one or more websites, social media platforms, and metaverse environments, including the website and metaverse hosting the viewing of the synthesized short-form video. The viewer information can be analyzed by an AI machine learning model and can be used to select an individual that can appeal to the viewer to encourage further engagement and the purchase of highlighted items for sale in the synthesized short-form video.

In embodiments, the media sources can include one or more photographs, videos, livestream events, and livestream replays, including the voice of the individual. In some embodiments, the photorealistic representation can include a 360° representation of the individual. The individual can comprise a human host that can be recorded with one or more cameras, including videos and still images, and microphones for voice recording. The recordings can include one or more angles of the human host and can be combined to comprise a dynamic 360° photorealistic representation of the human host. The voice of the human host can be recorded and included in the representation of the human host.

The example 400 includes isolating 420, using one or more processors, the photorealistic representation 410 of the individual from within the one or more media sources, wherein the isolating is accomplished by machine learning. In embodiments, the media sources can include photographs, videos, livestream events, livestream replays, and recordings of a human host. The media sources can include the voice of the individual. The isolating of the photorealistic representation by machine learning can be accomplished by training a convolutional neural network (CNN) to recognize and classify images. As images are processed by the CNN, they are converted into signal data and normalized. The images are then passed through a series of algorithms that filter and separate out unnecessary objects, such as background and non-human objects. This process is called segmentation. The CNN will then detect features in the remaining human image, such as facial features and body proportions, and classify them. Once the images have been classified, the CNN will assign them to specific categories. Thus, detailed physical information of the individual can be extracted, categorized, and used to create a 3D model of the individual.

The example 400 includes creating a 3D model 430 of the individual, wherein the 3D model is based on a game engine 440. As mentioned above and throughout, a game engine 440 is a set of software applications that work together to create a framework for developers to build and create video games. In embodiments, the isolated and categorized photorealistic images of the individual can be used as input to a machine learning game engine that can build a detailed 3D model of the individual, including the voice of the individual extracted from the video and livestream recordings. The game engine 440 can include a Character Movement Component that provides common modes of movement for 3D humanoid characters, including walking, falling, swimming, crawling, and so on. These default movement modes are built to replicate by default and can be modified to create customized movements, such as skiing, skydiving, or riding a motorcycle, as part of a product demonstration. Facial features can be edited to appear more lifelike, including storing unique and idiosyncratic elements of a human face. Articles of clothing can be similarly edited to perform as they do in real life. Lighting presets can be used to place individual characters in photorealistic environments so that light sources, qualities, and shadows appear lifelike. Voice recordings can be used to generate dialogue with the same vocal qualities as the individual. Volume, pitch, rhythm, frequency, and so on can be manipulated within the game engine to create realistic dialogue for the 3D model of the individual.

A performance, by the individual that was modeled, can be synthesized. The performance can be based on animation using the game engine 440. In embodiments, a game engine can be used to generate a series of animated movements, including basic actions such as sitting, standing, holding a product, presenting a video or photograph, describing an event, and so on. Specialized movements can be programmed and added to the animation as needed. Dialogue can be added so that the face of the presenter moves appropriately as the words are spoken. The 3D model of the individual can be used as the performer of the animation after the sequence of movements and dialogues have been decided. The result is a synthesized photorealistic performance by the selected individual, combining the animation generated by the game engine 440 and the 3D model of the individual, including the voice of the individual. The synthesized performance can be generated as a short-form video to be rendered directly to a webpage or social media platform or stored to be viewed later.

The example 400 includes rendering, to a viewer, a short-form video 470, wherein the short-form video includes the performance that was synthesized, an interactive overlay, and an ecommerce environment 480. In embodiments, the machine learning game engine can be used to generate a short-form video and play it for a viewer on a webpage 460, as part of a livestream event, on a social media platform, etc. An ecommerce environment 480 can be rendered to include a virtual purchase cart and on-screen product cards 490 as part of the short-form video 470. A device 450 used to view the rendered synthetic host short-form video 470 can be an Over-the-Top (OTT) device such as a mobile phone, laptop computer, tablet, pad, or desktop computer; etc. The viewing of the short-form video can be accomplished using a browser or another application running on the device 450. A product card 490 can be generated and rendered on the device 450 used to view the short-form video. In embodiments, the product card 490 represents at least one product available for purchase on the website or social media platform hosting the short-form video or highlighted during the short-form video. Embodiments can include inserting a representation of a product for sale into the on-screen product card. Viewers can initiate and complete a purchase completely inside of the short-form video user interface, without being directed away from the currently playing video.

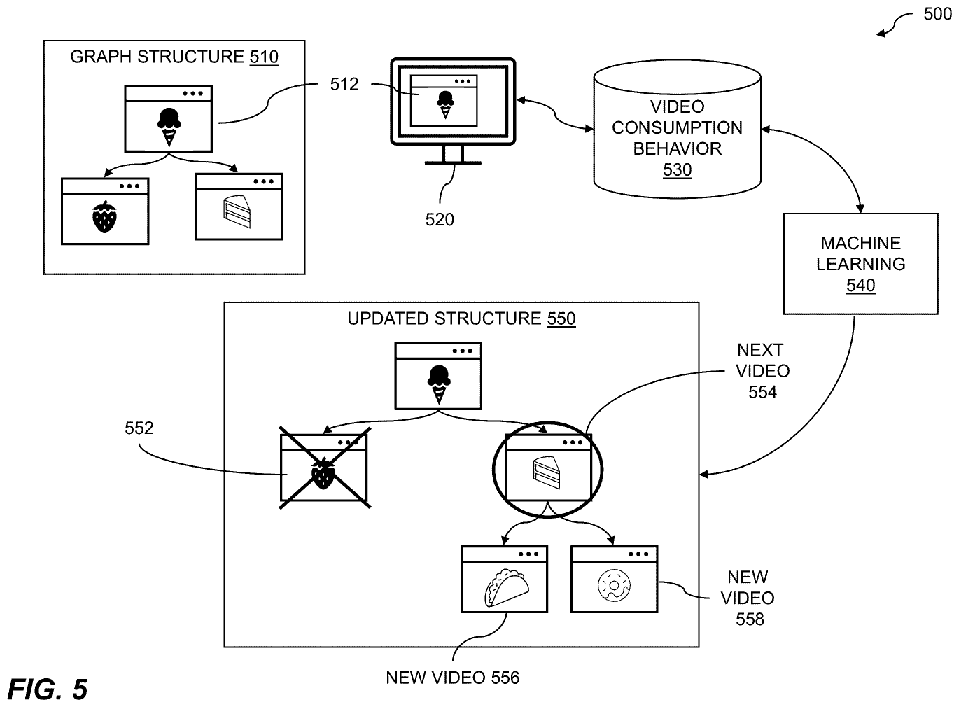

FIG. 5 is an infographic for updating a tree structure. Updating a tree structure can enable dynamic short-form video traversal with machine learning in an ecommerce environment. A graph structure associated with a library of short-form videos is accessed and customized in a back-end environment based on products for sale on a website. One or more of the customized short-form videos from the library is rendered to one or more users, along with an interactive overlay and an ecommerce environment. As the video is viewed, video consumption behavior data is collected and analyzed by a machine learning model. The machine learning model determines one or more next short-form videos from the graph structure for the user to view, based on sales goals, video consumption behavior data, and interaction with the user. The machine learning model can synthesize additional short-form videos and insert them into the graph structure in order to enhance viewer engagement and product sales.

The infographic 500 includes an initial graph structure 510. The initial graph structure can comprise a tree graph, although other graph structures may be employed. The initial graph structure can be developed in a back-end environment by a variety of processes, but the initial graph structure is developed related to a particular business line, business segment, store focus, etc. for an ecommerce site. In the infographic 500, the initial graph structure 510 is shown for a business line of consumable foods, which can include such foods as ice cream, cake, fruit, donuts, tacos, burritos, salty snacks, and so on. The initial graph structure can be set by the back-end process based on previous ecommerce site sales, industry trends, advertiser spending, etc.

The infographic 500 includes rendering a short-form video 520 from a library of short-form videos. The short-form video chosen to be rendered is based on the initial entry that is populated in the graph structure 510, for example, a short-form video highlighting an ice cream cone 512. The ice cream cone short-form video is then deployed on one or more ecommerce websites, apps, advertisements, etc. The response to the short-form video can be monitored and used to generate a video consumption behavior database 530. The video consumption behavior can include many elements of viewer engagement such as total number of video views; duration of video viewing; clicking through to links contained within or near the video; viewer questions, responses, ratings, and “likes”; product sales of the viewed short-form video product; and so on. As new short-form videos, selected from initial graph tree structure, are rendered, the video consumption behavior database can be updated.

The infographic 500 includes updating a machine learning model 540, based on the video consumption behavior database 530. The machine learning model 540, of course, can be continuously updated based on changes to the video consumption behavior database. Various weights can be given to various database elements and database metrics (i.e., from above: total number of video views; duration of video viewing; clicking through to links contained within or near the video; viewer questions, responses, ratings, and “likes”; product sales of the viewed short-form video product; and so on) for use in updating the model.

The infographic 500 includes updating the graph structure 550, based on the machine learning model 540. To illustrate, in a certain ecommerce environment (e.g., website, time/day, region, viewer demographic, etc.), the machine learning model determines that sweets, such as ice cream, are performing well. The model then updates the graph structure to prune fruits 552 from the structure and promote cake as the next video 554. In addition, further short-form videos can be added to the updated structure, such as savory taco new video 556 and sweet donut new video 558. Then, as next video 554 is rendered, based on updates to the video consumption behavior database and resulting machine learning model updates, still further short-form videos can be added to the graph structure. For example, if taco new video 556 produces desirable results, then additional savory items can be added from the library of short-form videos to the graph structure; or if donut new video 558 produces desirable results, then additional sweet items from the library of short-form videos can be added to the graph structure. Therefore, some embodiments comprise re-customizing the graph structure, wherein the re-customizing is based on the video consumption behavior. In embodiments, the re-customizing is based on machine learning.

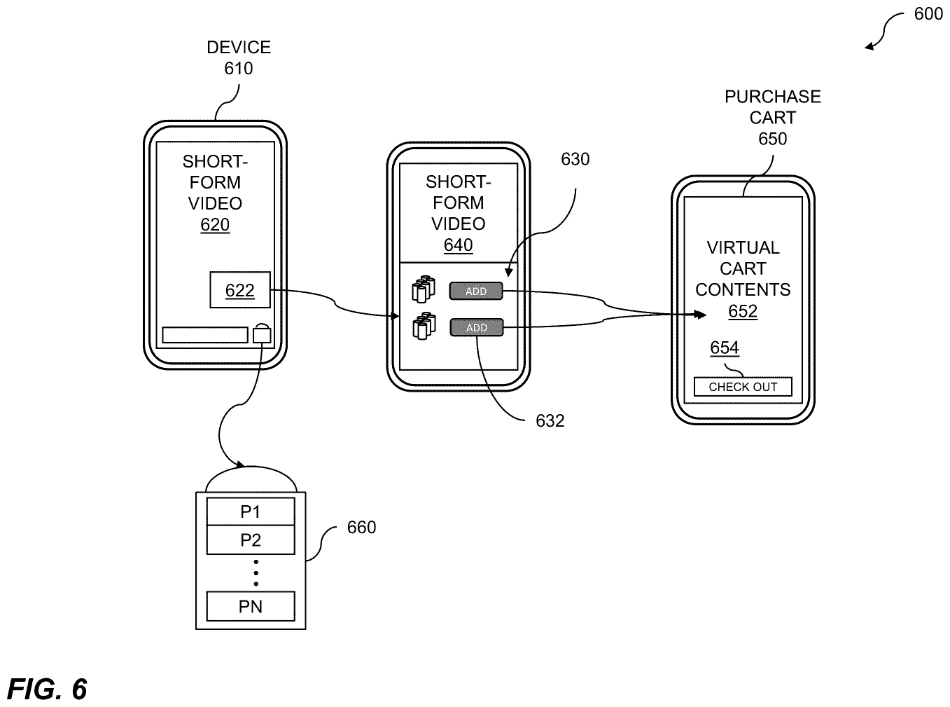

FIG. 6 illustrates an ecommerce purchase. An ecommerce purchase can be enabled by dynamic short-form video traversal with machine learning in an ecommerce environment. A graph structure associated with a library of short-form videos is accessed and customized in a back-end environment based on products for sale on a website. One or more of the customized short-form videos from the library are rendered to one or more users, along with an interactive overlay and an ecommerce environment. As the video is viewed, video consumption behavior data is collected and analyzed by a machine learning model. The machine learning model determines one or more next short-form videos from the graph structure for the user to view, based on sales goals, video consumption behavior data, and interaction with the user. The machine learning model can synthesize additional short-form videos and insert them into the graph structure in order to enhance viewer engagement and product sales.

The illustration 600 includes a device 610 displaying a short-form video 620 as part of a livestream event. In embodiments, the livestream can be viewed in real time or replayed at a later time. The device 610 can be a smart TV which can be directly attached to the Internet; a television connected to the Internet via a cable box, TV stick, or game console; an Over-the-Top (OTT) device such as a mobile phone, laptop computer, tablet, pad, or desktop computer; etc. In embodiments, the accessing the livestream on the device can be accomplished using a browser or another application running on the device.

The illustration 600 includes generating and revealing a product card 622 on the device 610. In embodiments, the product card represents at least one product available for purchase while the livestream short-form video plays. Embodiments can include inserting a representation of the first object into the on-screen product card. A product card is a graphical element such as an icon, thumbnail picture, thumbnail video, symbol, or other suitable element that is displayed in front of the video. The product card is selectable via a user interface action such as a press, swipe, gesture, mouse click, verbal utterance, or other suitable user action. The product card 622 can be inserted when the livestream is visible in the livestream event short-form video 640. When the product card is invoked, an in-frame shopping environment 630 is rendered over a portion of the video while the video continues to play. This rendering enables an ecommerce purchase 632 by a user while preserving a continuous video playback session. In other words, the user is not redirected to another site or portal that causes the video playback to stop. Thus, viewers are able to initiate and complete a purchase completely inside of the video playback user interface, without being directed away from the currently playing video. Allowing the livestream event to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The illustration 600 includes rendering an in-frame shopping environment 630 enabling a purchase of the at least one product for sale by the viewer, wherein the ecommerce purchase is accomplished within the livestream event short-form video window 640. In embodiments, the livestream event can include the livestream and/or a prerecorded video segment. The enabling can include revealing a virtual purchase cart 650 that supports checkout 654 of virtual cart contents 652, including specifying various payment methods, and application of coupons and/or promotional codes. In some embodiments, the payment methods can include fiat currencies such as United States dollar (USD), as well as virtual currencies, including cryptocurrencies such as Bitcoin. In some embodiments, more than one object (product) can be highlighted and enabled for ecommerce purchase. In embodiments, when multiple items 660 are purchased via product cards during the livestream event, the purchases are cached until termination of the video, at which point the orders are processed as a batch. The termination of the video can include the user stopping playback, the user exiting the video window, the livestream ending, or a prerecorded video ending. The batch order process can enable a more efficient use of computer resources, such as network bandwidth, by processing the orders together as a batch instead of processing each order individually.

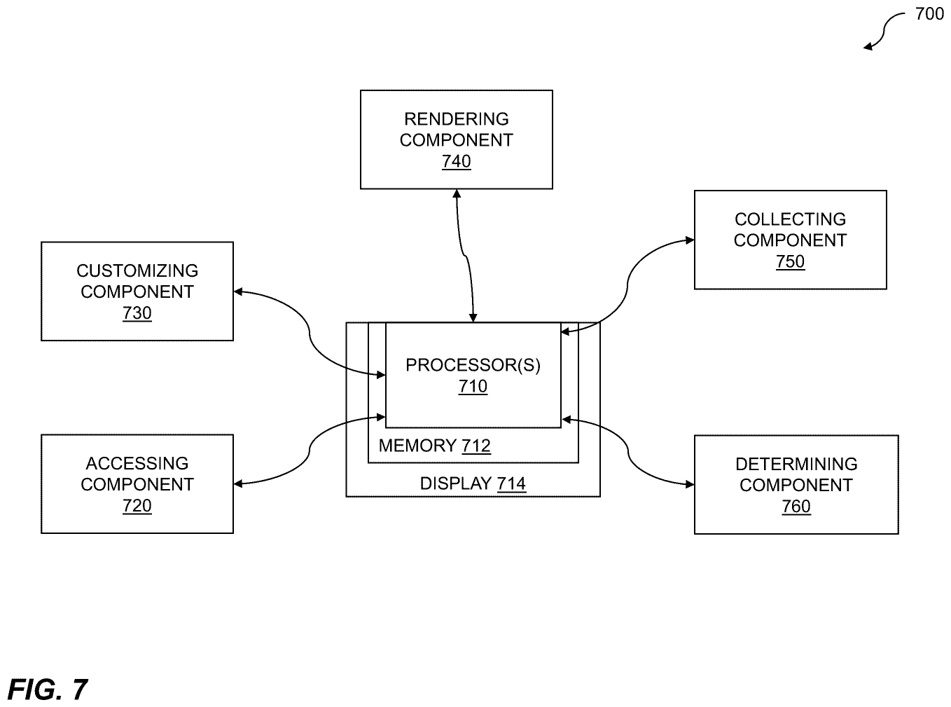

FIG. 7 is a system diagram for dynamic short-form video traversal with machine learning in an ecommerce environment. The system 700 can include one or more processors 710 coupled to a memory 712 which stores instructions. The system 700 can include a display 714 coupled to the one or more processors 710 for displaying data, video streams, videos, intermediate steps, instructions, and so on. In embodiments, one or more processors 710 are coupled to the memory 712 where the one or more processors, when executing the instructions which are stored, are configured to: access a graph structure associated with a plurality of short-form videos, wherein the plurality of short-form videos is selected from a library of short-form videos; customize the graph structure in a back-end environment, wherein the customizing is based on one or more products for sale on a website; render, to a user, at least one of the plurality of short-form videos in accordance with the graph structure; collect, from the user, video consumption behavior, as the plurality of short-form videos is rendered; and determine, based on the video consumption behavior, one or more next short-form videos to be shown, wherein the determining is based on a sales goal and wherein the determining is accomplished by a machine learning model.

The system 700 includes an accessing component 720. The accessing component 720 can include functions and instructions for accessing a graph structure associated with a plurality of short-form videos, wherein the plurality of short-form videos is selected from a library of short-form videos. In embodiments, the graph structure associated with the plurality of short-form videos includes a tree structure. The graph structure is displayed in a back-end environment. The library of short-form videos can be compiled from multiple sources, including vendor websites, social media platforms, livestreams, marketing videos, product expert demonstrations, and so on. The graph structure is a decision support model that uses a tree-like model of decisions and possible consequences. In some embodiments, the graph tree structure can be displayed visually as a series of nodes or decision points connected by lines leading to additional decision point nodes. In some embodiments, the decision graph structure is displayed in a left-to-right orientation. Other embodiments can display the graph structure in a top-to-bottom arrangement. Each user choice or decision point can represent a short-form video that can lead a user to select another related short-form video. As a user selects the first short-form video to view at the left side or top of the graph, a series of choices representing the possible next steps can be represented as a series of lines leading to subsequent user choices. Additional information can be added to the graph structure to indicate decisions to purchase products, to return to a previous video, to rewatch a video, to stop watching videos, and so on. As the user continues to make choices, the active decision point progresses from left to right or top to bottom, traversing the graphical display. In embodiments, each choice made by the user is stored and fed into a machine learning model, along with information related to the short-form videos being viewed, products being purchased, and so on.

The system 700 includes a customizing component 730. The customizing component 730 can include functions and instructions for customizing the graph structure in a back-end environment, wherein the customizing is based on one or more products for sale on a website. In embodiments, the customizing includes adding an interactive overlay to one or more of the plurality of short-form videos that were selected from the library. A list of products and services for sale on a website can be stored and associated with short-form videos stored in the library of short-form videos. The associations can be based on metadata on each product or service, including product name, category, sizes, price, color, and so on. In some embodiments, the associations can be made by a machine learning model. The machine learning model can analyze the contents of the short-form videos in the library and match product names, categories, and so on to products and services supplied by an ecommerce website. As matches are made between products offered by the ecommerce website and short-form videos in the library, the graph structure can be customized to display the matched short-form videos and a first-pass arrangement of the short-form videos based on associations between the matched short-form videos. The first-pass arrangement can be assembled by one or more human operators or by the machine learning model. For example, a short-form video highlighting a soup pot can be linked to another short-form video demonstrating the preparation of a soup recipe. The same soup pot video can also be linked to a short-form video highlighting a set of soup bowls. Another link can be made to a short-form video highlighting a complete set of cooking vessels, and so on. At each decision tree point, additional information can be collected related to viewer decisions to purchase products, ask questions, make comments, stop watching, and so on.

The system 700 includes a rendering component 740. The rendering component 740 can include functions and instructions for rendering, to a user, at least one of the plurality of short-form videos in accordance with the graph structure. In embodiments, the rendering includes a plurality of users. One or more users can be presented with one or more short-form videos related to a product or service for sale on an ecommerce website. The rendering of the short-form videos can be based on a question or comment made by a user, on a click or other form of selection of a product displayed on the website, or in response to a direct user selection of the video from the website. The rendering includes an interactive overlay which allows the user to respond to the short-form video as it plays. Questions or comments can be recorded; choices of additional short-form videos can be presented and selected; options to purchase products or services portrayed in the video can be chosen; options to replay the short-form video, go back to a previous video, or stop watching videos can be selected; and so on. As described in later steps, an ecommerce environment can be rendered with the interactive overlay so that the user can select items to be purchased immediately or at a later time.

The system 700 includes a collecting component 750. The collecting component 750 can include functions and instructions for collecting, from the user, video consumption behavior, as the plurality of short-form videos is rendered. In embodiments, the user includes a plurality of users. The collecting further comprises identifying the user. Metadata related to the one or more users, including the user's name, location, purchases, payment preferences, likes, number of visits, hashtags, repost velocity, view attributes, view history, ranking, influencers followed, and so on can be collected. Data from the website, including purchase history, shipping information, etc., can also be collected. The viewer consumption information can include likes, dislikes, view count, click through rate (CTR), view duration, percentage viewed, text comments and questions, purchase choices, and responses to questions generated by the machine learning model.

The system 700 includes a determining component 760. The determining component 760 can include functions and instructions for determining, based on the video consumption behavior, one or more next short-form videos to be shown, wherein the determining is based on a sales goal and wherein the determining is accomplished by a machine learning model. A machine learning model is comprised of a group of computer programs that is used to recognize patterns in data and make predictions. The programs are created from machine learning algorithms that can be trained with data based on the types of predictions desired from the model. In embodiments, the machine learning model can be trained with website and user metadata, short-form videos, video metadata, purchase history, product information, and so on, in order to predict patterns of short-form video viewing and engagement choices that lead to purchases of products and services. As viewers interact and respond to multiple groups of short-form videos, over time the machine learning model becomes better at predicting traversal patterns of short-form video views that result in greater engagement and purchase choices. The machine learning model can also generate questions and choices that lead viewers to select a next short-form video best suited to selecting additional short-form videos and to purchasing products. In embodiments, the next short-form video to be shown can be customized based on one or more products for sale on a website. The customizing includes adding an interactive overlay to one or more of the plurality of short-form videos that were selected from the library. The determining further comprises checking to determine if the one or more products for sale is in stock. As the machine learning model takes in viewer responses to the short-form video, questions can be put to the user that can lead to additional short-form videos. For example, a user watching a short-form video on golf can be asked, “What would you like to do today?” including choices such as “Improve Your Swing”, “Take Online Lessons”, and “Shop for Gear”. Each option can be linked to a short-form video from the customized graph structure. The short-form videos can be customized to highlight products that have been confirmed to be in stock and available for purchase from the ecommerce website.

In some embodiments, the determining component 760 further comprises synthesizing a next short-form video to be shown to the user, wherein the synthesizing is accomplished by machine learning. In embodiments, the synthesized next short-form video can be customized based on one or more products for sale on a website. The customizing includes adding an interactive overlay to the synthesized short-form video. The synthesized next short-form video can be added to the graph structure. As the machine learning model takes in viewer consumption behavior data and short-form video information, it can find patterns that lead to viewers leaving the ecommerce site or abandoning the short-form video platform. It may record questions or comments made by users that relate to products being offered by the ecommerce website, but have no related short-form video available in the video library. The machine learning model may find that a short-form video related to a comment, question, or selected based on a machine learning model interaction results in no next video being chosen. Any of these patterns can lead to the machine learning model synthesizing a short-form video designed to better engage the viewer and lead to purchases being made.

In embodiments, the machine learning model can access photorealistic representations of individuals from one or more media sources. The media sources can include photographs, videos, livestream events, and livestream replays, including the voice of the individual. The machine learning model can isolate the representations of an individual in videos and photographs and use them to generate a 3D model of the individual. In some embodiments, the photorealistic representation can include a 360° representation of an individual. The first individual can comprise a human host that can be recorded with one or more cameras, including videos and still images, and microphones for voice recording. The recordings can include one or more angles of the human host and can be combined to comprise a dynamic 360° photorealistic representation of the human host. The voice of the human host can be recorded and included in the representation of the human host.

The 3D model of the individual can be generated and refined using a game engine. A game engine is a set of software applications that work together to create a framework for users to build and create video games. They can be used to render graphics, generate and manipulate sound, create and modify physics within the game environment, detect collisions, manage computer memory, and so on. In embodiments, the isolated and categorized photorealistic images of an individual can be used as input to a machine learning game engine that can build a detailed 3D model of the individual, including the voice of the individual extracted from the video and livestream recordings. The game engine can include a Character Movement Component that provides common modes of movement for 3D humanoid characters including walking, falling, swimming, crawling, and so on. These default movement modes are built to replicate by default and can be modified to create customized movements, such as skiing, scuba diving, or demonstrating a product. Facial features can be edited to appear more lifelike, including storing unique and idiosyncratic elements of a human face. Articles of clothing can be similarly edited to perform as they do in real life. Lighting presets can be used to place individual characters in photorealistic environments so that light sources, qualities, and shadows appear lifelike. Voice recordings can be used to generate dialogue with the same vocal qualities as the first individual. Volume, pitch, rhythm, frequency, and so on can be manipulated within the game engine to create realistic dialogue for the 3D model of the individual. The game engine can be used to generate a series of animated movements, including basic actions such as sitting, standing, holding a product, presenting a video or photograph, describing an event, and so on. Specialized movements can be programmed and added to the animation as needed. Dialogue can be added so that the face of the presenter moves appropriately as the words are spoken. The 3D model of the host individual can be used as the performer of the animation after the sequence of movements and dialogues have been decided. The result is a synthesized performance by the selected host model, combining the animation generated by the game engine and the 3D model of the individual, including the voice of the individual. The synthesized performance can be used to create the next short-form video that can better respond to viewer questions or comments related to a previous short-form video and can raise viewer engagement and sales choices. Once the synthesized short-form video is generated, it can be added to the customized graph structure and rendered to the viewer, including an interactive overlay and ecommerce environment. As the machine learning model takes in viewer consumption behavior related to the synthesized short-form video, it can adjust the performance of the host, the highlighting of the product, and so on in order to generate higher viewer engagement and sales scores.

The determining component 760 further comprises enabling an ecommerce purchase, within an ecommerce environment, of one or more products for sale, wherein the enabling the ecommerce purchase includes a virtual purchase cart. In embodiments, the rendering further comprises displaying, within the at least one of the plurality of short-form videos that was rendered, the virtual purchase cart. In some embodiments, the virtual purchase cart covers a portion of the at least one of the plurality of short-form videos that was rendered. The at least one of the plurality of short-form videos that was rendered includes highlighting the one or more products for sale to the user. The enabling further comprises representing the one or more products for sale in an on-screen product card. The enabling the ecommerce purchase includes a virtual purchase cart, wherein the rendering further comprises displaying, within the first short-form video that was rendered, the virtual purchase cart. The virtual purchase cart can cover a portion of the first short-form video. A device used to view the rendered short-form video can be an Over-the-Top (OTT) device such as a mobile phone, laptop computer, tablet, pad, or desktop computer, etc. The viewing of the short-form video can be accomplished using a browser or another application running on the device. A product card can be generated and rendered on the device for viewing the short-form video. In embodiments, the product card represents at least one product available for purchase on the website or social media platform hosting the short-form video or highlighted during the short-form video. Embodiments can include inserting a representation of a product for sale into the on-screen product card. A product card is a graphical element such as an icon, thumbnail picture, thumbnail video, symbol, or another suitable element that is displayed in front of the video. The product card is selectable via a user interface action such as a press, swipe, gesture, mouse click, verbal utterance, or some other suitable user action. When the product card is invoked, an in-frame shopping environment can be rendered over a portion of the short-form while the chat continues to play. This rendering enables an ecommerce purchase by a user while preserving a short-form video session. In other words, the user is not redirected to another site or portal that causes the short-form video to stop. Thus, viewers can initiate and complete a purchase completely inside of the short-form video user interface, without being directed away from the currently playing video. Allowing the short-form video to play during the purchase can enable improved audience engagement, which can lead to additional sales and revenue, one of the key benefits of disclosed embodiments. In some embodiments, the additional on-screen display that is rendered upon selection or invocation of a product card conforms to an Interactive Advertising Bureau (IAB) format. A variety of sizes are included in IAB formats, such as for a smartphone banner, mobile phone interstitial, and the like.

The system 700 can include a computer program product embodied in a non-transitory computer readable medium for video analysis, the computer program product comprising code which causes one or more processors to perform operations of: accessing a graph structure associated with a plurality of short-form videos, wherein the plurality of short-form videos is selected from a library of short-form videos; customizing the graph structure in a back-end environment, wherein the customizing is based on one or more products for sale on a website; rendering, to one or more users, at least one of the plurality of short-form videos in accordance with the graph structure; collecting, from the user, video consumption behavior, as the plurality of short-form videos are rendered; and determining, based on the video consumption behavior, one or more next short-form videos to be shown, wherein the determining is based on a sales goal and wherein the determining is accomplished by a machine learning model.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams, infographics, and flowchart illustrations depict methods, apparatus, systems, and computer program products. The elements and combinations of elements in the block diagrams, infographics, and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A computer-implemented method for video analysis comprising:
accessing a graph structure associated with a plurality of short-form videos, wherein the plurality of short-form videos is selected from a library of short-form videos;
customizing the graph structure in a back-end environment, wherein the customizing is based on one or more products for sale on a website;
rendering, to a user, at least one of the plurality of short-form videos in accordance with the graph structure;
collecting, from the user, video consumption behavior, as the plurality of short-form videos are rendered; and
determining, based on the video consumption behavior, one or more next short-form videos to be shown, wherein the determining is based on a sales goal and wherein the determining is accomplished by a machine learning model.

2. The method of claim 1 further comprising synthesizing a next short-form video to be shown to the user, wherein the synthesizing is accomplished by the machine learning model.

3. The method of claim 2 further comprising adding an interactive overlay to the next short-form video to be shown which was synthesized, wherein the adding is accomplished by machine learning.

4. The method of claim 3 further comprising adding a coupon within the interactive overlay.

5. The method of claim 4 wherein the coupon is based on the sales goal.

6. The method of claim 2 wherein the next short-form video is added to the graph structure.

7. The method of claim 1 wherein the graph structure associated with the plurality of short-form videos includes a tree structure.

8. The method of claim 1 wherein the determining further comprises checking to determine if the one or more products for sale is in stock.

9. The method of claim 1 wherein the customizing includes adding an interactive overlay to one or more of the plurality of short-form videos that were selected from the library.

10. The method of claim 1 wherein the rendering, collecting, and determining includes a plurality of users.

11. The method of claim 1 wherein the collecting further comprises identifying the user.

12. The method of claim 11 wherein the determining is based on the identifying.

13. The method of claim 1 further comprising enabling an ecommerce purchase, within an ecommerce environment, of the one or more products for sale.

14. The method of claim 13 wherein the enabling the ecommerce purchase includes a virtual purchase cart.

15. The method of claim 14 wherein the rendering further comprises displaying, within the at least one of the plurality of short-form videos that was rendered, the virtual purchase cart.

16. The method of claim 14 wherein the virtual purchase cart covers a portion of the at least one of the plurality of short-form videos that was rendered.

17. The method of claim 13 wherein the at least one of the plurality of short-form videos that was rendered includes highlighting the one or more products for sale to the user.

18. The method of claim 17 further comprising representing the one or more products for sale in an on-screen product card.

19. The method of claim 1 wherein the graph structure is displayed in the back-end environment.

20. The method of claim 19 further comprising re-customizing the graph structure, wherein the re-customizing is based on the video consumption behavior.

21. The method of claim 20 wherein the re-customizing is based on machine learning.

22. A computer program product embodied in a non-transitory computer readable medium for video analysis, the computer program product comprising code which causes one or more processors to perform operations of:
accessing a graph structure associated with a plurality of short-form videos, wherein the plurality of short-form videos is selected from a library of short-form videos;
customizing the graph structure in a back-end environment, wherein the customizing is based on one or more products for sale on a website;
rendering, to a user, at least one of the plurality of short-form videos in accordance with the graph structure;
collecting, from the user, video consumption behavior, as the plurality of short-form videos are rendered; and
determining, based on the video consumption behavior, one or more next short-form videos to be shown, wherein the determining is based on a sales goal and wherein the determining is accomplished by a machine learning model.

23. A computer system for video analysis, comprising:
a memory which stores instructions;
one or more processors attached to the memory wherein the one or more processors, when executing the instructions which are stored, are configured to:
access a graph structure associated with a plurality of short-form videos, wherein the plurality of short-form videos is selected from a library of short-form videos;
customize the graph structure in a back-end environment, wherein customizing is based on one or more products for sale on a website;
render, to a user, at least one of the plurality of short-form videos in accordance with the graph structure;
collect, from the user, video consumption behavior, as the plurality of short-form videos are rendered; and
determine, based on the video consumption behavior, one or more next short-form videos to be shown, wherein determining is based on a sales goal and wherein the determining is accomplished by a machine learning model.
